(19) United States
(12) Patent Application Publication
(10) Pub. No.: US 2008/0164212 A1
(43) Pub. Date: Jul. 10, 2008

(54) Method for Determining and Controlling the Formation of Deposits In a Water System

(75) Inventor: Lotta Kanto Oqvist, Kempen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: ASHLAND LICENSING AND INTELLECTUAL PROPERTY LLC., Dublin, OH (US)

(21) Appl. No.: 11/908,362

(22) PCT Filed: Mar. 17, 2006
(86) PCT No.: PCT/EP2006/002464

§ 371 Date: Sep. 11, 2007

(30) Foreign Application Priority Data
Mar. 17, 2005 (DE) 10 2005 012 824.6

(51) Int. Cl. B01D 15/08

(52) U.S. Cl. 210/656; 436/161; 95/82; 436/171

(57) ABSTRACT

The invention relates to a method for determining and controlling inorganic and/or organic deposits in a water system, preferably a paper and/or board machine re-circulation system. According to said method, one or more probes are introduced into the water system, then removed from said system after a pre-selected exposure period and prepared for surface analysis. The deposits that have accumulated on the probes are determined by means of microscopy methods and/or gas chromatography methods and/or mass spectrometry methods.

The invention relates to a process for the determination and control of inorganic and/or organic deposits in an aqueous system, preferably a paper and/or board machine circulatory system.

In technology in general and particularly in hydraulic engineering, the phenomenon of deposits forming in technical plants that either impair plant performance or yield a deterioration in product quality is known as fouling. Fouling can be differentiated according to its origin or the nature of the deposited substances.

Purely inorganic deposits are known as scale, e.g. limescale or boiler scale deposits in heat exchangers, cooling towers and reverse osmosis plants etc. [see also Flemming, H. -C.: “Biofilme und Wassertechnologie”, Tell II: Unerwüinschte Biofilme—Phänomene und Mechanismen. Gwf Wasser Abwasser 133, No. 3 (1992)].

If these deposits are of largely biological origin, i.e. they contain not only other mostly organic substances such as metabolic products or extracellular polymeric substances (known as EPS for short in the following), but also viable organisms—mostly microorganisms as well as molluscs and other higher forms of life—the term “biofouling” is used.

Blanco et al. also classify such deposits according to their origin into non-biological (stickles, resin and limescale/boiler scale) and biological (slime) (see Blanco M. A., Negro C., Gaspar I., and Tijero J., Slime problems in the paper and board industry. Appl. Microbiol Biotechnol (1996) 46:203-208). To understand the mechanism of deposit formation during papermaking, Kanto Öqvist et al. use a different classification that distinguishes between organic (including biological slime) and inorganic nature (see Kanto Öqvist L., Jörstad U., Pöntinen H., Johnsen L., Deposit control in the paper industry, 3rd ECOPAPERTECH Conference, June 2001, 269-280).

The term “biofouling” is also associated with the term “biofilm”:

Biofilms represent a special form of colonization by microorganisms that can occur on boundary surfaces, i.e. virtually anywhere, as there are practically no surfaces in the environment that are not colonized or capable of colonization by microorganisms. Nor are any materials yet known which are capable of resisting microbial colonization in the long term [Charaklis, W. G., Marshall, K. C.: “Biofilms: a basis for an interdisciplinary approach” in W. G. Charaklis, K. C. Marshall (EDS), “Biofilms”, John Wiley, New York (1990), p. 3-15].

Over and above this, biofilms and biofilm organisms represent the oldest so far known form of life and are among the most adaptable forms of life of all. They are encountered not only in natural water bodies, but also in places commonly considered hostile to life.

In technical systems, biofilms can be found, for example, in nutrient-depleted plants for the production of super-pure water as well as in the pipework systems of the paper industry.

As already indicated, inorganic and/or organic deposits and particularly biofilms are capable of having an extremely disruptive effect in technical plants and thus cause immense economic loss. Over and above this, it has been shown that the problems caused particularly by biofouling in technical plants are extremely varied.

Highly significant in this context is, for example, microbially induced corrosion (MIC), since microbial films can cause or exacerbate corrosion, particularly on metal surfaces. In this process, biofilm organisms accelerate the electrochemical processes concomitant with corrosion.

Owing to the special viscoelastic properties of biofilms, the populated surfaces show a significantly greater frictional resistance, which in pipework systems or heat exchangers can result in a diminished feed rate, increased loss of pressure or deterioration in heat transfer. In extreme cases, this may culminate in the blockage of entire pipework systems and the congestion of heat exchangers.

Another major problem, for instance, is the tearing-off of biofilm fragments. In the paper industry, this not only causes soiling of the paper, but can also cause plant shutdown with the resultant negative economic consequences.

Furthermore, with respect to the problem of inorganic and/or organic deposits, and particularly that of fouling or biofouling, it should be mentioned that the complete exclusion of such deposits in technical plants is in many cases either impossible or, from the financial point of view, only possible at unacceptably high expense. This means that, for example, undesired biofilm formation is tolerated up to a certain threshold value, and the required measures to reduce or combat these inorganic and/or organic deposits are initiated when this threshold value is exceeded.

To be able to estimate the necessity to initiate such countermeasures and check the success of their effectiveness, there is a need for monitoring processes or systems that supply the measurement parameters permitting reliable statements on the current state of the system of interest.

The methods for system surveillance or monitoring processes are basically divided into two groups. The first group concerns methods requiring the removal of a piece of the affected surface from the system so that the deposit concerned can be released from it and investigated. Such methods, also known as destructive methods, are classical or biochemical processes that make use of conventional laboratory measuring processes.

Destructive methods familiar from the prior art make use of, for example, removable culture surfaces of biofilms which are separately installed in the plant and removed again. To this end, culture surfaces or so-called coupon systems are exposed at representative positions in the system so that they can be removed after the desired times and analysed with the aid of offline laboratory measuring processes [see US 831 H].

Another classical monitoring method is, for instance, the slime measurement board that has already been in use for a long time in papermaking [Klahre, J.; Lustenberger, M.; Flemming, H. -C.: Mikrobielle Probleme in der Papierfabrik—Teil 3: Monitoring. Das Papier 10 (1998), p. 590-596].

However, the disadvantage of such laboratory measuring processes is that they call for a considerable input of labour and time in terms of manpower, materials and equipment. Moreover, these methods demand a meticulously constant treatment of the test surfaces or coupons if the growth or decline in the film and non-method-related variations are to be measured. Furthermore, the measuring points are not always readily accessible or representative of the overall system, e.g. the flow conditions prevalent at the measuring point may differ from those usually present in the system, which has direct effects on the structural development of the biofilm on the culture surface.

Because of the above-mentioned drawbacks of destructive methods, a variety of efforts are being made today to determine the extent of biofouling in real time (online) and directly within the system (inline or in a bypass) and non-destructively, i.e. without active intervention in the process. Nonetheless, it should be mentioned with respect to the destructive and offline methods known from the prior art that many of these laboratory methods supply more accurate results in the daily practice of observing inorganic and organic deposits and particularly biofilms than, for example, some of the inline measuring instruments currently available on the market. Consequently, such destructive methods are the No. 1 choice if highly precise results are required for the system under observation or if only a short observation period has to be covered.

As already outlined, deposits such as microbial slime are responsible for a multitude of problems during papermaking. These can lead to loss of quality, reduced machine availability and increased costs (see Blanco M. A., Negro C., Gaspar I., and Tijero J., Slime problems in the paper and board industry. Appl. Microbiol Biotechnol (1996) 46:203-208).

The deposits in the machine circuit, and particularly in a paper and/or board machine circulatory system, arise as a result of substances that are introduced into the system by aerosols and by raw materials such as fresh water, wood substances, fillers and chemical additives. To be able to develop effective countermeasures, it is therefore essential that the interactions between these substances and microorganisms, from their first occurrence through to massive deposit formation, are known and understood (see Kanto Öqvist L., Jörstad U., Pöntinen H., Johnsen L, Deposit control in the paper industry, 3rd ECOPAPERTECH Conference, June 2001, 269-280; Mattila K., Weber A., Salkinoja-Salonen M. S., Structure and on-site formation of biofilms in paper machine water flow (2002). J Industr Microbiol Biotechnol 28, 268-279). Nevertheless, most suggestions for deposit control have been based so far on measurements in the aqueous phase that do not permit reliable statements on the current state of the system of interest.

For example, in relation to the deposition of biofilms, it has been ascertained that there is no relationship between the number of cells measured in the aqueous phase and the number of cells in the conglomerate adhering to the surface. Since, therefore, the determination of the germ count in the liquid phase does not permit any reliable conclusions to be drawn about the contribution towards deposit formation, this method is unsuitable, as the synthesis of EPS depends not only on the bacterial species and number, but also quite essentially on their state of nutrition [Klahre, J.; Lustenberger, M.; Flemming, H. -C.: Mikrobielle Probleme in der Papierfabrik—Teil 3: Monitoring. Das Papier 10 (1998), p. 590-596].

With respect to deposit formation, it is assumed that an initiating film is first formed (Schenker A. P., Singleton F. L., Davis C. K. (1998), Proc. EUCEPA, Chemistry in Papermaking, 12-14 October: 331-354,) by means of which the microbes can dock onto a surface more readily. In this connection, reference should be made to the investigations of Kolari et al who have described the difficulties faced by bacteria when populating a cleaned steel surface (see Kolari M., Nuutinen J., Salkinoja-Salonen M. S., Mechanism of biofilm formation in paper machine by Bacillus species: the role of Deincoccus geothermalis (2001). J Industr Microbiol Biotechnol 27:343-351), with strains of bacteria from the paper industry being employed.

Since there is still a great demand for an investigation process that permits reliable statements on the current state of an aqueous system of interest, it was therefore the object of the present invention to make available such a process, particularly in order to be able to determine inorganic, microbial and/or organic deposits in an aqueous system, preferably in a paper and/or board machine circulatory system. Furthermore, the process should also make it possible to objectively observe and understand the formation of deposits on surfaces and the interactions between inorganic, organic and microbial material in the aqueous system, so that various treatment programmes for the respective aqueous systems can be assessed, particularly for each paper and/or board machine circulatory system. It is necessary that the process operates in situ so as to cover if possible all parameter changes in the system, such as pH, temperature, chemical additives, raw materials, re-used waste material, flow rates; and/or the process must be a destructive method in order to obtain very precise results and hence reliable statements on the current state of the aqueous system of interest.

The inventive object is accomplished by a process for the determination and control of inorganic, microbial and/or organic deposits in an aqueous system, preferably a paper and/or board machine circulatory system, with one or more specimens being introduced into the aqueous system which are removed again from the system after a preselected exposure period and prepared for a surface examination, with the deposits formed on the specimens being determined with microscopic methods and/or gas-chromatographic and/or mass-spectroscopic methods.

Surprisingly, it has been discovered with the aid of the inventive process that the formation of deposits, particularly in papermaking, is not simply attributable solely to microbial activity, but in fact interactions between inorganic and organic material and the effect of microorganisms are responsible for this. On the basis of this understanding, it is then possible to design treatment programmes that are tailored to the specific case, require fewer toxic products (biocides) and are usually also less expensive.

According to the invention, one or more specimens are introduced into the aqueous system under investigation, preferably a paper and/or board machine circulatory system. The number of the specimens to be used for the inventive process depends on the aqueous system under investigation. Particularly if the inventive process is employed in a paper and/or board machine circulatory system, the coupons are always placed in precisely those places where problems have occurred in the past and the growth of deposits is to be studied. Care must in this case be taken to ensure that the process operates in situ so as to cover if possible all parameter changes in the system, such as pH, temperature, chemical additives, raw materials, re-used waste material, flow rates, etc. in order to allow realistic assessment of the system at the growth surface of the specimens at the problem location to be examined. This is not possible if the specimens are located, for example, in a bypass of the aqueous system. Preferably used as the specimens are conventional coupon systems that are introduced, for example, at certain positions in the papermaking process, e.g. in tanks, containers for additives, splashed water areas or simply in all positions with wetting or high humidity.

Not only in terms of the multitude of different components and plants in aqueous systems on which film problems can occur, the expert fundamentally has an abundance of materials at his disposal from which specimens can be produced, e.g. stainless steel, C steel, various metal alloys, plastic, ceramics, glass etc. In many technical aqueous systems, such as cooling water, service water, process water and drinking water and in many production plants (e.g. paper and board machines), stainless steel is a representative material for the inventive specimens, the specimens being preferably made of acid-resistant stainless steel.

In an especially preferred embodiment, the specimen is a round stainless steel coupon of 2 mm thick AISI 316 I stainless steel with a 1 mm hole by which the coupon can be fastened or suspended at a suitable position in the system under investigation. Nonetheless, according to the invention, coupons can also have other shapes and dimensions as specimens.

To fasten the specimens, acid-resistant stainless steel wires and other fastening means suitable for this purpose can be used, for example.

The specimen(s) is/are left for the preselected exposure period in the aqueous system under investigation. At the end of the selected period, the specimen(s) is/are removed from the system and prepared for the subsequent surface examinations. The exposure period to be selected depends on the aqueous system under investigation and particularly on its susceptibility to deposits and can be determined with simple trial tests. The exposure period to be selected usually comes to between one hour and 100 days, preferably from 1 to 50 days, with an exposure period between several hours and 15 days, particularly up to 1, 2, 3 to 12 days being particularly preferred according to the invention.

The specimens removed from the system are then prepared directly as fresh samples for the surface examinations, especially fixed and subsequently analysed or initially fixed at the aqueous system to be observed, wherein the subsequent analysis can then be carried out at a later point in time.

The deposits formed on the specimens are determined with microscopic methods, particularly with electron-microscopic methods and/or electron-spectroscopic methods. The surfaces of the specimens, particularly coupons, are preferably investigated after exposure with special microscopic methods, e.g. scanning electron microscopy (SEM) with energy-dispersive X-ray analyses (EDX) as well as, for example, with speed mapping or confocal laser scanning microscopy (CLSM) and epifluorescence microscopy (EP).

According to the invention, the organic portion of the deposits can preferably be determined by gas-chromatographic and/or mass-spectroscopic methods. According to the invention, the gas-chromatographic and/or mass-spectroscopic methods can also be coupled with other analysis methods. For instance, gas chromatography (GC) can be coupled with infrared spectroscopy (IR spectroscopy), in which case IR spectroscopy serves as the detector for GC. Other GC detectors include flame-ionization detectors (FID), thermal conductivity detectors, photoionization detectors (PID), the electron-capture detector (ECD), thermoionic detector (TID), flame photometric detector (FPD), Hall detector (HECD) and thermal energy analyser (TEA) etc. Preferred detectors or couplings with GC are Fourier transform infrared spectrometers (FT-IR) and mass spectrometers. Furthermore, infrared microscopy is one of the preferred methods for investigating organic deposits.

Determination is carried out particularly preferably by pyrolysis gas chromatography with a coupled mass spectrometer (abbreviated in the following to Py-GC/MS).

The inventive process is particularly advantageous, as it makes it possible to investigate the formation of deposits on surfaces in a wide variety of aqueous systems, e.g. in paper machine systems. The aim of the investigation is to analyse the actual structure of the deposits in the machine system under observation, starting from initial deposition to complete bulk formation. On the basis of the findings obtained, it is then possible to develop an effective treatment programme to prevent a build-up of deposits harmful to the machines. The products to be employed in such a treatment programme are, for instance, antiscalants, dispersing agents, biocides, fixing agents etc. The choice of one or more of the above-mentioned products for a treatment programme tailored to a system under investigation depends on the results obtained by using the inventive process.

The inventive process differs advantageously from other processes known from the prior art by virtue of its detailed analysis of the deposition mechanism on the surfaces of the system and, in particular, it does not analyse what is circulating in the system.

The inventive process is explained in greater detail with reference to the following examples and attached figures.

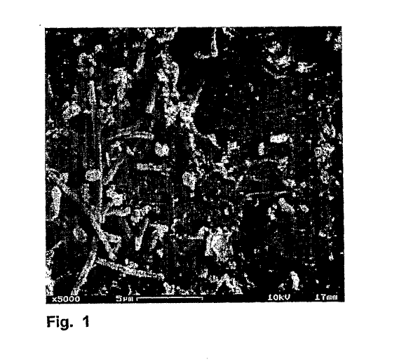

FIG. 1: SEM image of a steel coupon surface. The coupon was in the wire water channel of a board machine using 100% secondary fibres for 6 days.

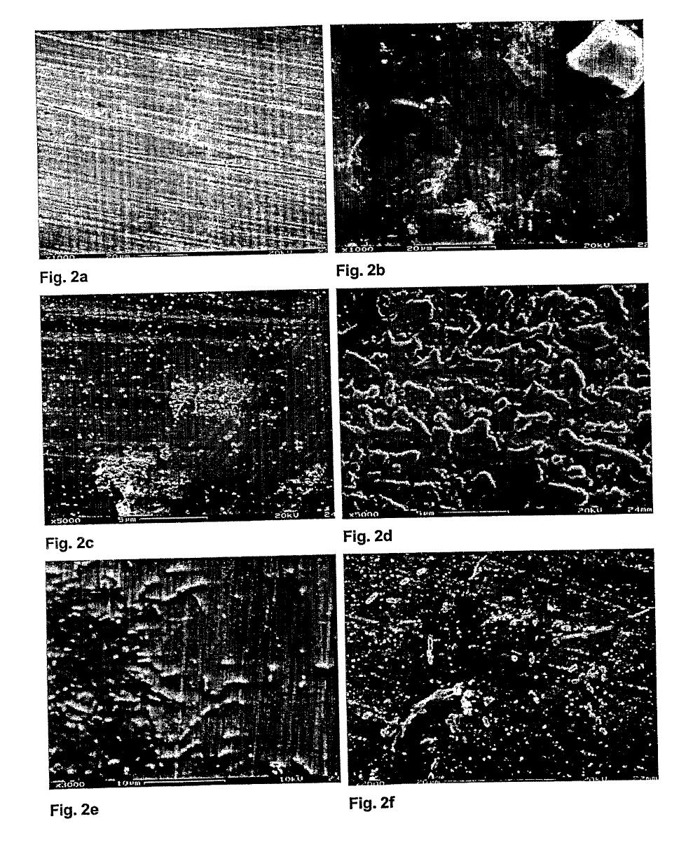

FIG. 2a: SEM image of a steel coupon surface. Exposure for 1 day in the wire water of a newsprint paper machine using 100% thermo-mechanical pulp (TMP).

FIG. 2b: SEM image of a steel coupon surface. Exposure for 6 days in the wire water of a newsprint paper machine using 100% TMP.

FIG. 2c: SEM image of a steel coupon surface. Exposure for 1 day at the outlet of a dilution headbox. Production of fine paper from bleached hardwood/softwood.

FIG. 2d: SEM image of a steel coupon surface. Exposure for 6 days at the outlet of a dilution headbox. Production of fine paper from bleached hardwood/softwood.

FIG. 2e: SEM image of a steel coupon surface. Exposure for 1 day downstream from a board machine using 100% secondary fibres.

FIG. 2f: SEM image of a steel coupon surface. Exposure for 12 days downstream from a newsprint paper machine using 100% TMP.

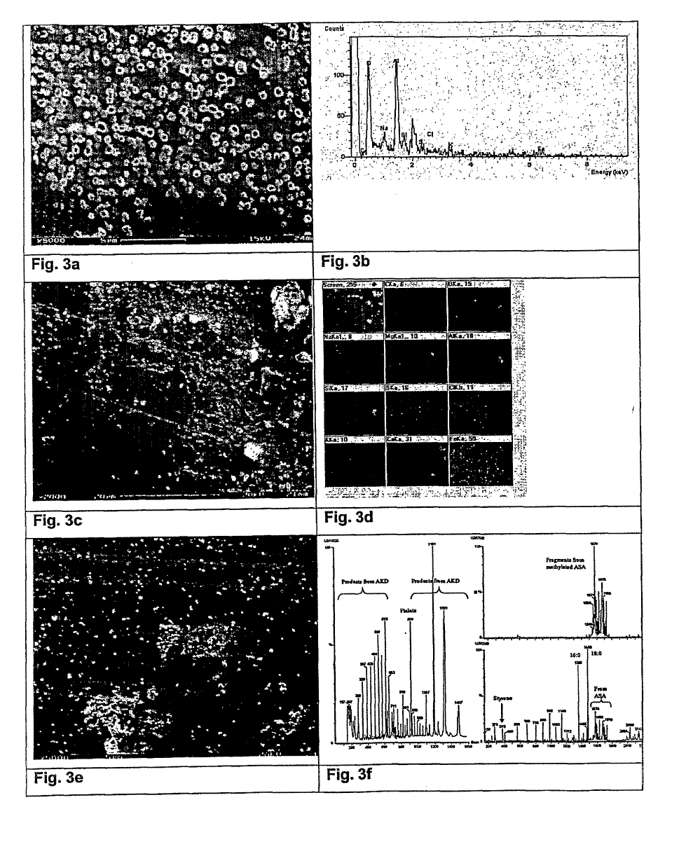

FIG. 3a: SEM image of a steel coupon. Exposure for 1 day in the wire water of a board machine. 100% secondary fibres.

FIG. 3b: EDX analysis of the image in FIG. 3a.

FIG. 3c: SEM image of a steel coupon. Exposure for 1 day in the wire water of a board machine. 100% secondary fibres.

FIG. 3d: EDX speed map of the image in FIG. 3c.

FIG. 3e: SEM image of a steel coupon surface. Exposure for 1 day in the outlet of a dilution headbox. Production of fine paper from bleached hardwood/softwood.

FIG. 3f: Py-GCMS analysis of a deposit from the same place as in FIG. 3e.

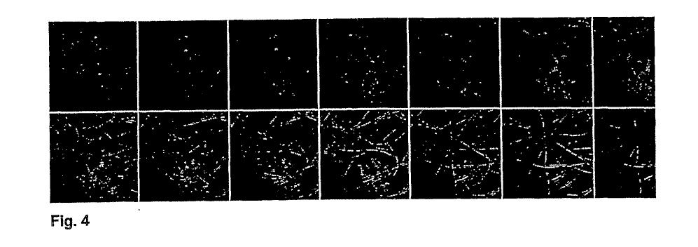

FIG. 4: CLSM image of a steel coupon. Exposure for 9 days in the biological white water of a board mill. 100% secondary fibres.

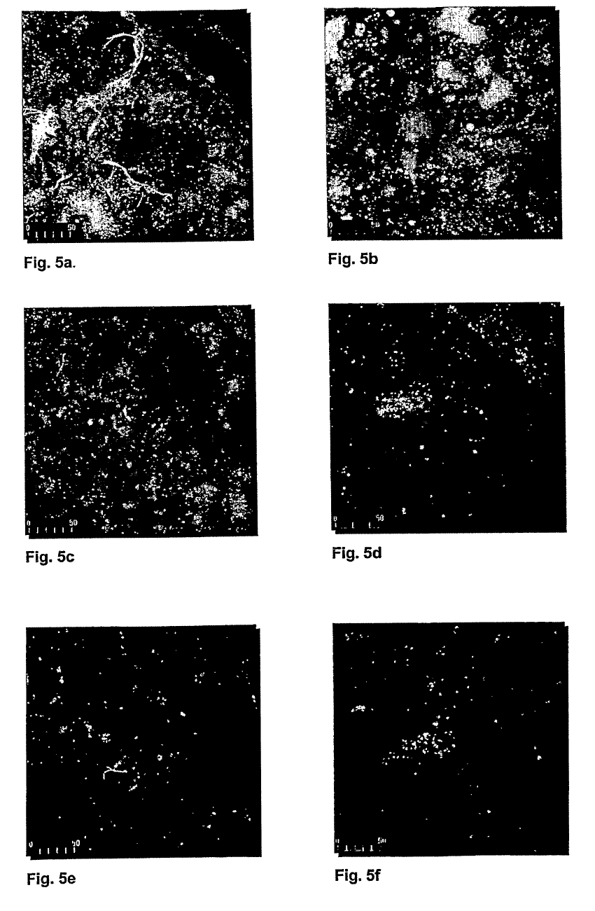

FIG. 5a: CLSM image of a steel coupon surface. Exposure for 5 days in a flow cell. No anti-slime agent. Total germ count=10⁷ cfu/ml (cfu=colony−forming units).

FIG. 5b: CLSM image of a steel coupon surface. Exposure for 5 days in a flow cell. Treated with isothiazolinone, 200 ppm product. Total germ count=<1000 cfu/ml.

FIG. 5c: CLSM image of a steel coupon surface. Exposure for 5 days in a flow cell. Treated with DBNPA (dibromonitrile propionamide), 40 ppm product. Total germ count=<1000 cfa/ml.

FIG. 5d: CLSM image of a steel coupon surface. Exposure for 5 days in a flow cell. Treated with peracetic acid, 60 ppm product. Total germ count=<1000 cfu/ml.

FIG. 5e: CLSM image of a steel coupon surface. Exposure for 5 days in a flow cell. Treated with a multifumctional deposit control agent (dispersion of a hydrophobic substance), 30 ppm product. Total germ count=10⁷ cfa/ml.

FIG. 5f: CLSM image of a steel coupon surface. Exposure for 5 days in a flow cell. Treated with a multifunctional deposit control agent (emulsion of a solvent), 50 ppm product. Total germ count=10⁷ cfu/ml.

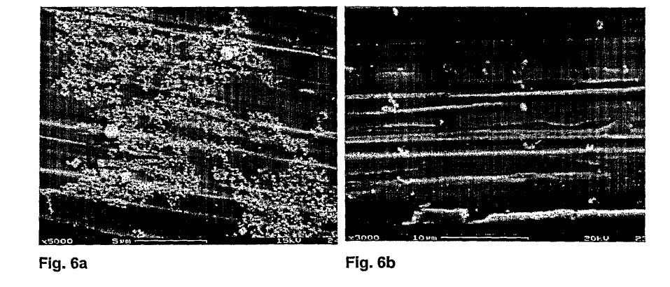

FIG. 6a: SEM image of a steel coupon surface. Exposure for 4 hours in a flow cell. No anti-fouling agent.

FIG. 6b: SEM image of a steel coupon surface. Exposure for 4 hours in a flow cell. Treated with a multifunctional deposit control agent (MDCA).

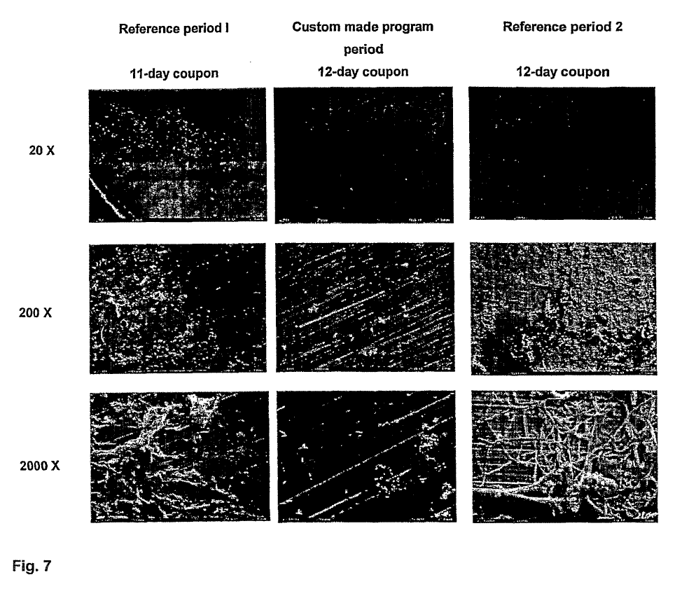

FIG. 7: SEM images of several steel coupon surfaces. Exposure for 12 days in the wire water of a newsprint paper machine. 100% secondary fibres. The reference sample was treated only with biocide in comparison with a custom-made programme consisting of a combination of a multifunctional deposit control agent (MDCA) and biocides.

### MATERIALS AND METHODS

Before use, the coupons were polished with FEPA P1000 (Struers) water-resistant abrasive paper and then cleaned first with a detergent and subsequently with acetone. The thus treated coupons of 2 mm thick AISI 316L stainless steel with a diameter of 15 mm and a drilled hole were introduced at various places in the paper or board machines, usually in places of high humidity in which the occurrence of deposits had been observed. Acid-resistant steel wires were used to immerse the coupons directly in containers or water-bearing channels.

After a suitable exposure period, for example after 1, 2, 3, 4, 5, 6, 7, 8, 9, 10, 11 or 12 days, the coupons were removed and prepared for the surface examinations (SEM/EDX or CLSM).

### Fixing of Acid-Resistant Stainless Steel Coupons for SEM Examinations

For the SEM examinations, the surfaces can be fixed as described, for example, by Väisänen et al., 1998, (see Väisänen O. M., Weber A., Bennasar A., Rainey F. A., Busse H. -J., Salkinoja-Salonen M. S. Microbial communities of printing paper machines. J Appl Microbial (1998) 84: 1069-1084).

According to Kolari M., Mattila K., Mikkola R., Salkinoja-Salonen M.S. (Community structure of biofilms on ennobled stainless steel in Baltic Sea water (1998). J Industr Microbiol Biotechnol 21:261-274), the coupon must be rinsed in slightly flowing water, in which case the coupon is held vertically with tweezers, for instance. The coupon is then placed for 2 hours in freshly produced 3% glutardialdehyde, produced with the aid of Sorensen buffer (a mixture of KH₂PO₄ and Na₂HPO₄). The glutardialdehyde is washed off by immersing the coupon in 3 different containers of freshly produced Sorensen buffer. It is important that the colonized side of the coupon remains coated at all stages.

To remove water from the sample, the coupon is placed in an ethanol gradient of 40%, 60%, 80% and 96% for 15 minutes in each case. After the 15 minutes in 96% ethanol, the excess ethanol is removed and the coupon is left for a while to dry.

After fixing with the method described here, the coupon is then analysed by SEM with EDX analysis.

### Fixing of Acid-Resistant Stainless Steel Coupons for CLSM and EP Examinations

For epifluorescence microscopy (EP) and confocal laser scanning microscopy (CLSM), the same acid-resistant stainless steel coupons are conventionally used as for SEM. However, unlike SEM coupons, the coupons are left in the system for differently preselected exposure periods. These are then analysed either as fresh samples or after fixing on the mill.

The fixing time depends on the nature of the sample. With a formaldehyde and glutardialdehyde mixture, the period is usually 1 to 2 hours at room temperature. Since fixing with formaldehyde at low concentrations (<4%) is an equilibrium reaction, the washing steps after fixing should be short. The osmolarity can be adjusted with saccharose.

### Fixing Agents

The commonest fixing agents are aldehydes, either pure or in mixtures. The key element in fixing agents is usually parafornaldehyde at a concentration of 2 to 4%.

### 4% Paraformaldehyde in PBS (Phosphate Buffer Solution)

4 g paraformaldehyde is added to 60 ml PBS and the solution is heated to 60° C. 1 N NaOH is slowly added until the solution becomes clear. It is left to cool to room temperature. It is set to a pH of 7.4 (e.g. with 1 N NaOH or 1 N HCl). It is then topped up with PBS to a total volume of 100 ml, portioned and stored at −20° C. To prevent precipitation, it must be quickly melted in a water bath.

Both in epifluorescence microscopy (EP) and in confocal laser scanning microscopy, special colours are used in order, for example, to dye certain active groups or microbe groups known as the causes of problems, e.g. EPS material, live/dead strands, DNA/RNA strands etc. These colours show the quantity and distribution of the microbes, slime or other conceivable material in the interior of the deposit film.

CLSM yields a 3-dimensional depiction of the deposit film and is thus more informative than epifluorescence microscopy. The disadvantage of the CLSM method, however, is that it is more time-consuming than epifluorescence microscopy.

The coupons for CLSM are examined according to a method by Kolari et al., 1998, in which live organisms can be distinguished from dead ones with the aid of a special dye (Molecular Probes Inc.) (see Kolari M., Mattila K., Mikkola R., Salkinoja-Salonen M. S. Community structure of biofilms on ennobled stainless steel in Baltic Sea water (1998). J Industr Microbiol Biotechnol 21:261-274).

The examination of the organic portion of the deposits was carried out by pyrolysis gas chromatography with a coupled mass spectrometer (Py-GC/MS). The results are obtained as a program, with the intensity of the pyrolysis product against retention time (on the total ion current (TIC) detector). 2 mass spectra were recorded per second in order to detect the structural features of the pyrolysis products. Since many polar compounds, above all acids, were not volatile enough for the nonpolar GC columns employed, methylation with tetramethylammonium hydroxide (TMAH) was carried out directly in the pyrolysis.

Furthermore, conventional platings on agar (Plate Count Agar from Merck, Darmstadt, Germany) were also carried out to obtain an indication of the total germ counts.

### II. The Use of Steel Coupons to Investigate Deposit Formation in the Paper Industry

Coupons were introduced at various places in various paper and board machines in order to investigate the build-up of deposits and understand the mechanisms behind them. After the given exposure time (between 1 and 14 days), they were removed and immediately fixed for SEM analyses. The analyses were performed with SEM-EDX.

On the surfaces of the coupons, one can see different types of deposits. An example of a deposit with interactions between inorganic, organic and microbial material is shown in FIG. 1.

A particularly advantageous feature of the inventive process is that the nature of the initial film of the deposit can be determined.

After an exposure period of a week, complex deposits containing all three basic types are usually found.

### III. Deposit Types in Various Boundary Surfaces in the Area of the Paper Machine

FIGS. 2a-f show examples of coupons introduced in the area of various boundary surfaces within paper and board machines. They show the different structures of deposits at different places in the paper machine. Immediately after removal, the coupons were fixed and examined with SEM-EDX.

In gas-liquid boundary surfaces, the aerobic areas of the cycles, the initial film can sometimes be detected after only 1 hour of exposure time. In FIG. 2a, the initial film consists of organic material. Anything morphologically suggesting bacteria or other microorganisms can be scarcely found. The structure of the deposit at the same place after exposure of 6 days shows a complex composition (see FIG. 2b).

In the area of the liquid-solid boundary surfaces (FIG. 2c), no microorganisms can be ascertained, and equally no inorganic material that can be detected with EDX. Pyrolysis GC/MS, on the other hand, shows a high proportion of AKD/ASA (alkylketone dimers/alkenylsuccinic anhydride) in this deposit. The same deposit after exposure of 6 days is shown in FIG. 2d.

Gas-solid boundary surfaces are found in the paper machine in places not exposed to constant wetting. The typical deposits in these places consist of inorganic salts and microorganisms (FIGS. 2e-f). Deposits of this kind are found, for example, on spray tubes from which the slime often hangs down in points.

In the various boundary surfaces in the area of the paper machine, the composition of the deposits therefore varies greatly.

### IV.

### A. Case Studies 1 to Illustrate Why the Planning of a Deposit Control Concept Calls for a Sound Understanding of the Start of Deposit Formation.

Coupons were introduced into various systems. After a maximum of 1 day, they were removed and immediately fixed. Analysis was performed with SEM-EDX.

In the first case, a board machine using 100% secondary fibres, one can see an initial film containing aluminium and oxygen (FIGS. 3a-b). This is evidently aluminium hydroxide (corresponding to the pH of 6.8 in the wire water).

In case 2, also a board machine using 100% secondary fibres, one can identify a population of bacteria on the surface. Inorganic material has started to be deposited in the EPS of the bacteria (FIGS. 3c-d).

In case 3, an organic film becomes visible after 1 day. Definite classification is difficult, even if the pyrolysis GC/MS of a deposit sample from the same place detects a high share of AKD/ASA. Inorganic material could not be detected by EDX analysis. The typical morphological pattern of microorganisms is not evident here either (FIGS. 3e-f).

From these results, it can be concluded that the composition of the initial film on the coupon surface depends very strongly on the particular system. Nevertheless, it is very important to have knowledge of this initial film in order to be able to take effective countermeasures. This applies all the more, because usually it is not bacteria that initiate the formation of deposits, since, as has already been explained, many species are incapable of adhering to a purely metal surface (see Kolari M., Nuutinen J., Salkinoja-Salonen M. S., Mechanism of biofilm formation in paper machine by Bacillus species: the role of Deincoccus geothermalis (2001). J Industr Microbiol Biotechnol 27:343-351).

### B. Case Studies 2 to Illustrate the Insufficiency of Measurements of the Total Germ Count for the Preparation of a Deposit Control Concept

Microbial platings were carried out on a conventional agar. Concurrently, coupons were examined on which the microorganisms were stained with a selective dye to distinguish between live and dead species. These surfaces were analysed with confocal laser scanning microscopy (CLSM). The investigated systems were wire water and biological water from the same paper mill (100% secondary fibres).

In biological water that was returned to the process, <1000 cfu/ml were found by plating on agar. On the coupon surface (after 9 days in the same flow of water), about 30 filamentous bacteria and approximately 300 bacilli were found per unit of area (50 μm×50 μm=0.0025 mm², FIG. 4). This corresponds to 12,000 filamentous bacteria and approximately 120,000 bacilli per mm². It was shown that only certain species of the overall microbiological activity could be plated well. This means that there is no correlation between slime formation and the colony count obtained by counting an aerobic culture.

Special problems in papermaking are caused by filamentous bacteria. These species are well-known for causing quality and so-called runnability problems because of their morphology. Unfortunately, it is precisely these filamentous bacteria that, without special pre-treatment, are very difficult to cultivate on agar (Ramothokang T. R. and Drysdale G. D., Isolation and cultivation of filamentous bacteria implicated in activated sludge bulking. Water SA Vol. 29 No. 4 October 2003, 405-410).

The microbial plating of aerobic bacteria is not therefore helpful towards understanding a deposit problem and the design of a suitable treatment programme. In order to really understand the conditions and design an effective deposit control concept, deposit formation on surfaces should be investigated and understood.

Case Studies 3: Checking the Effectiveness of Anti-Slime Agents with the Aid of Coupon Technology

The aim was to determine the correlation between the results of a conventional biocide screening and the real formation of slime deposits. The investigations were carried on the wire water of a newsprint paper machine using 100% TMP. With a biocide screening, it was possible to determine the optimum biocide concentration for the achievement of a germ count reduction by 10² within 30 minutes. In order to follow slime formation at this biocide concentration, a flow cell system with suspended coupons was employed.

The wire water, which was also used for the biocide screening, was poured into the storage bottles of this system and enriched with a number of clots of slime from the wire water channel. The investigation was carried out at system temperature (in this case 48° C.). During the test period of 5 days, biocide was dosed daily. After exposure, the coupons were immediately selectively dyed in order to distinguish between live and dead organisms and then analysed with CLSM. Samples were plated on an agar medium (aerobically) at the same time.

In the various tests, large differences were achieved in germ count reduction (difference>10⁴ cfu/ml). These differences in microbial activity did not, however, reflect what was found on the surfaces, as FIGS. 5a-g show.

The green-stained bacteria on the surfaces are active (live). This shows that microorganisms that are enveloped in their biofilm react much less sensitively to biocide doses (FIGS. 5b-d). This also concurs with the findings described in the literature (see Kolari M., Nuutinen J., Rainey F. A., Colored moderately thermophilic bacteria in paper-machine biofilms (2003), J Industr Microbiol Biotechnol 30: 225-238; Grobe K. J., Zahller J., Stewart P. S., Role of dose concentration in biocide efficiency against Pseudomonas aereginosa biofilms (2002), J Industr Microbiol Biotechnol 29:10-15; Kanto Öqvist L., Jörstad U., Pöntinen H., Johnsen L., Deposit control in the paper industry, 3rd ECOPAPERTECH Conference, June 2001, 269-280; and Watnick P., Kolter R., Biofilm, City of Microbes. (2000), J Bacteriol, 182: 2675-2679). A reduction in deposition on the surfaces, on the other hand, is also possible without appreciably changing the number of microorganisms in the aqueous phase (see FIG. 5e-f).

It should be noted that the investigation of deposition and slime formation is essential for an assessment of the effectiveness of an anti-slime programme. Measurements (of the germ counts) in the aqueous phase are insufficient for this and in certain circumstances even misleading.

### Case Study 4: The Coupon Method as a Tool for the Prediction and Treatment of Deposition Problems

Further series of measurements were carried out in the flow cell setup, as described above. Again, real wire water was used and various sizing agents were dosed. In some tests, certain anti-fouling agents were employed. The coupons were removed after 4 hours and analysed with SEM.

As a result, a typical organic deposit of a calcium soap of ASA can be seen on the steel surface in FIG. 6a. Since the ASA deposit is very easy to detect, the effectiveness of the various anti-fouling agents can be assessed relatively easily with this method. In one case, a multifunctional deposit control agent was employed. The result of this flow cell experiment is given in FIG. 6b. One can clearly see that the addition effectively protects the steel surface from ASA deposition.

The steel coupon method combined with SEM is therefore suitable not only for investigating the effect and/or effectiveness of anti-slime agents, but also outstandingly suitable for observing the formation of deposits of organic contents (fouling).

### Case Study 5: The Coupon Method for the Development of Deposit Control Concepts in the Real System

The actual formation of deposits in a paper machine varies and depends on the type of machine, the raw materials, the quality of the untreated water, the treatment programmes, degree of circuit closure etc. The understanding of the build-up of deposits in the circuit increases the scope for developing a custom-made treatment programme that includes products capable of treating all three types of components of deposits (inorganic, microbial and organic), e.g. antiscalants, biocides and deposit control agents, inclusive of dispersing agents.

For example, if an initial analysis shows that the first deposit film was organic, a treatment programme consisting solely of biocides could not be effective. FIG. 7 shows how the deposits look after an 11 to 12-day treatment. As treatment programmes, a custom-made programme and a reference programme were applied. The custom-made programme was a combination of MFDA and biocides while the reference programme made use of biocides only.

Finally, the following can be stated about the use of the coupon method for the development of deposit control concepts in real systems:

The coupon method is suitable as an analytic tool in many different situations in the area of the paper machine, e.g.

To investigate the origin of the initial layer of a deposit

To predict and avoid changes in deposit susceptibility in the event of system changeover

To assess and compare the effectiveness of current and potential deposit control concepts

To assess the tendency of the contents of wire water to form deposits.

### As a Result of the Tests Performed, the Following can be Stated in Conclusion:

In terms of origin and composition, the initial layer of a deposit varies from paper machine to paper machine.

Determining the germ count in the aqueous phase by means of plating (counting) is not an effective aid to understanding deposit formation.

The assessment of the effectiveness of deposit control concepts presupposes an investigation of the deposit and of slime formation. Measurements in the aqueous phase are not expedient in this connection.

Steel coupons whose surfaces are analysed with SEM are an effective aid to the investigation of the formation of deposits of organic and inorganic substances and of slime problems. The effectiveness of various deposit control programmes can be realistically assessed and compared by using this method.

1. A process for the determination and control of inorganic and/or organic deposits in an aqueous system, preferably a paper and/or board machine circulatory system, with one or more specimens being introduced into the aqueous system, said specimens being removed from the system after a preselected exposure period and prepared for a surface examination, characterized in that the deposits formed on the specimens are determined with microscopic methods and/or gas-chromatographic and/or mass-spectroscopic methods.

2. The process according to claim 1, characterized in that the specimen(s) is/are introduced in tanks, containers for additives, splashed water areas or in all positions of the aqueous system under investigation with wetting or high humidity.

3. The process according to either claim 1 or claim 2, characterized in that the exposure period after which the specimen(s) is/are removed from the system is chosen so that the period ranges from one hour up to 100 days.

4. The process according to claim 3, characterized in that the specimen(s) is/are left for the preselected exposure period in the aqueous system under investigation and, at the end of the selected period, the specimen(s) is/are removed from the system and immediately prepared for the subsequent surface examinations, the specimens then being analysed as fresh samples or at a later point in time as samples fixed directly at the aqueous system to be observed.

5. The process according to any one of claims 1 to 4, characterized in that the deposits formed on the specimen(s) are determined with electron-microscopic methods and/or electron-spectroscopic methods.

6. The process according to any one of claims 1 to 5, characterized in that the deposits formed on the specimen(s) are determined with scanning electron microscopy (SEM), confocal laser scanning microscopy (CLSM) and epifluorescence microscopy (EP).

7. The process according to any one of claims 1 to 6, characterized in that the organic deposits formed on the specimen(s) are determined with pyrolysis gas chromatography with a coupled mass spectrometer (Py-GC/MS) or infrared microscopy.
